(19) United States
(12) Patent Application Publication
(10) Pub. No.: US 2006/0020790 A1
(43) Pub. Date: Jan. 26, 2006

(54) Authorization using ciphertext tokens in a content receiver

(76) Inventor: Eric J. Sprunk, Carlsbad, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/233,902

(22) Filed: Sep. 23, 2005

Related U.S. Application Data
(63) Continuation-in-part of application No. 09/827,630, filed on Apr. 6, 2001.
Application No. 09/827,630 is a continuation-in-part of application No. 09/580,503, filed on May 25, 2000, now Pat. No. 6,828,458.

(51) Int. Cl. H04L 9/00

(52) U.S. Cl. 713/167

(57) ABSTRACT

According to the invention, a method for securing a plaintext object within a content receiver is disclosed. In one step, a secure portion of a secure object and a plaintext remainder of the secure object are received. Which portion of the secure object is the secure portion is determined. The secure portion is decrypted to provide a plaintext portion. The plaintext object that comprises the plaintext portion and the plaintext remainder is formed. The plaintext object is stored. including authentication and authorization.

This application is a continuation-in-part of U.S. patent application Ser. No. 09/827,630 filed on Apr. 6, 2001, which was itself a continuation-in-part of U.S. patent application Ser. No. 09/580,503 filed on May 26, 2000.

### BACKGROUND OF THE INVENTION

This invention relates in general to secure access systems and, more specifically, to securing information in content receivers associated with conditional access systems.

Cable television (TV) providers distribute video streams to subscribers by way of conditional access (CA) systems. CA systems distribute video streams from a headend of the cable TV provider to a set top box associated with a subscriber. The headend includes hardware that receives the video streams and distributes them to the set top boxes within the CA system. Select set top boxes are allowed to decode certain video streams according to entitlement information sent by the cable TV provider to the set top box. In a similar way, other video program providers use satellite dishes to wirelessly distribute video content to set top boxes.

Video programs are broadcast to all set top boxes, but only a subset of those boxes are given access to specific video programs. For example, only those that have ordered a pay per view boxing match are allowed to view it even though every set top box may receive encrypted data stream for the match. Once a user orders the pay per view program, an entitlement message is broadcast in encrypted form to all set top boxes. Only the particular set top box the entitlement message is intended for can decrypt it. Inside the decrypted entitlement message is a key that will decrypt the pay per view program. With that key, the set top box decrypts the pay per view program as it is received in real-time. Some systems sign entitlement messages.

Only recently has storage of multiple hours of video become practical. Each video program is transmitted to set top boxes as a compressed MPEG2 data stream. One hour of video corresponds to about one gigabyte of compressed data. Since multigigabyte storage is common today, multiple hours of video can now be stored. In contrast, conventional CA systems presume content is ephemeral and cannot be stored. In other words, conventional systems are designed presuming that the video programs were too large to retain them for any period of time. As those skilled in the art can appreciate, the ability to store multigigabyte video programs spawns a need for additional security measures in CA systems.

Some systems integrate personal computing with a TV to display content. Interactive TV and Television-based internet access products, such as WebTV™ integrate web browsing and e-mail features with a TV. In other systems, a personal computer (PC) is connected to an Internet service provider (ISP) that provides the content for the web browsing and e-mail features. Software programs, such as the e-mail program, tend to be small and easily stored. Those skilled in the art recognize that these PCs do not provide adequate security such that they are susceptible to viruses and hackers.

As described above, conventional CA systems only check entitlement of video streams. With advent of larger storage and smaller Internet related programs, content can be stored and reside with the user for an indefinite period of time. To maintain control over this content, additional security measures are needed.

### BRIEF DESCRIPTION OF THE DRAWINGS

The present invention is described in conjunction with the appended figures:

FIG. 1 is a block diagram showing one embodiment of a content delivery system;

FIG. 2 is a block diagram illustrating an embodiment of a set top box interfaced to its environment;

FIG. 3 is a flow diagram showing an embodiment of a process for distributing an object in a first security level;

FIG. 4 is a flow diagram showing an embodiment of a process for distributing an object in a second security level;

FIG. 5 is a block diagram depicting an embodiment of an authorization message;

FIG. 6 is a block diagram showing an embodiment of a software message;

FIG. 7 is a block diagram illustrating an embodiment of a signatory group that includes portions of the authorization message and the software message;

FIG. 8 is a block diagram showing an embodiment of a “rights” message;

FIG. 9 is a block diagram illustrating an embodiment of interaction between functional units;

FIG. 10 is a flow diagram depicting an embodiment of a process for loading an object in a third security level;

FIG. 11 is a flow diagram showing an embodiment of a process for loading an object in a fourth security level;

FIG. 12 is a flow diagram depicting another embodiment of a process for loading an object in the fourth security level;

FIG. 13 is a flow diagram showing an embodiment of a process for checking continuously running objects in a fifth security level;

FIG. 14A is a flow diagram illustrating an embodiment of a process for allowing a free preview of an object in security level six;

FIG. 14B is a flow diagram illustrating another embodiment of a process for allowing a free preview of an object in security level six;

FIG. 15A is a flow diagram showing an embodiment of a process for monitoring reports back to a headend in security level seven;

FIG. 15B is a flow diagram showing an embodiment of a process for monitoring security checks in security level seven;

FIG. 15C is a flow diagram showing another embodiment of a process for monitoring security checks in security level seven;

FIG. 16A is a flow diagram of an embodiment of a process for producing partially-encrypted objects in an eighth level of security;

FIG. 16B is a flow diagram depicting an embodiment of a process for using execution tokens to achieve the eighth level of security;

FIG. 16C is a flow diagram depicting an embodiment of a process for using partial download to achieve the eighth level of security; and

FIG. 17 is a block diagram showing the relationship between different objects in a set top box.

### DESCRIPTION OF THE SPECIFIC EMBODIMENTS

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changed may be made in the function and arrangement of elements without departing from the spirit and scope of the invention as set for in the appended claims.

The present invention uses ciphertext tokens to enhance authorization in a television (TV) set top box. An object is stored in two portions where one portion is inaccessible before authorization. Encryption can be used to make the one portion inaccessible. The set top box decrypts the one portion after authorization to reformulate and use the object.

In the Figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

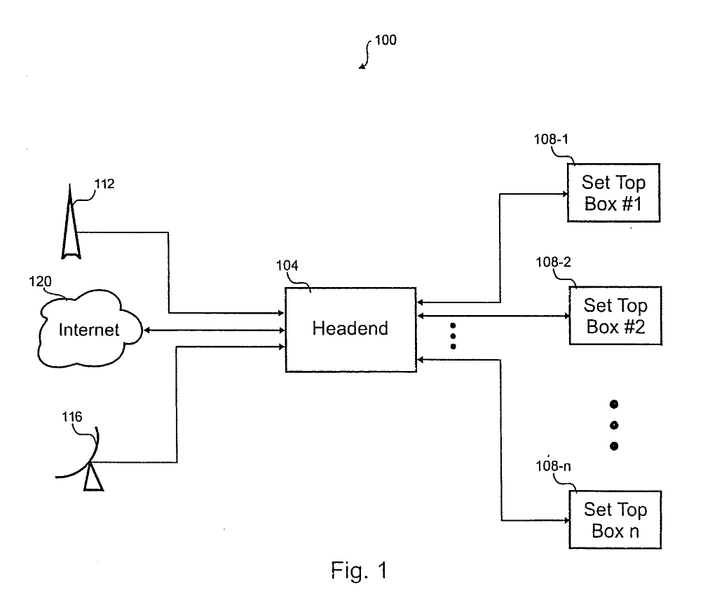

Referring first to FIG. 1, a block diagram of one embodiment of a content delivery system 100 is shown. The delivery system 100 selectively provides content to a number of users based upon certain conditions being satisfied. Included in the system 100 are a headend 104, number of set top boxes 108, local programming receiver 112, satellite dish 116, and the Internet 120.

The headend 104 receives content and distributes that content to users. Content can include video, audio, interactive video, software, firmware, and/or data. This content is received from a variety of sources that could include the satellite dish 116, the local programming receiver 112, a microwave receiver, a packet switched network, the Internet 120, etc. Each set top box 108 has a unique address that allows sending entitlement information to an individual set top box 108. In this way, one set top box 108-1 might be entitled to some particular content while another 108-2 might not. Equipment within the headend 104 regulates the subset of set top boxes 108 are entitled to some particular content.

The content is generally distributed in digital form through an analog carrier channel that contains multiple content streams. All the content streams are multiplexed together into a digital stream that is modulated upon the analog carrier channel. The separate content streams are tracked by packet identification (PID) information such that the individual content streams can be removed according to their unique PID information. There are around one hundred and twenty analog carrier channels in this embodiment of the system 100. Other embodiments could distribute the content with transport mechanisms that include satellite dishes, microwave antennas, RF transmitters, packet switched networks, cellular data modems, carrier current, phone lines, and/or the Internet.

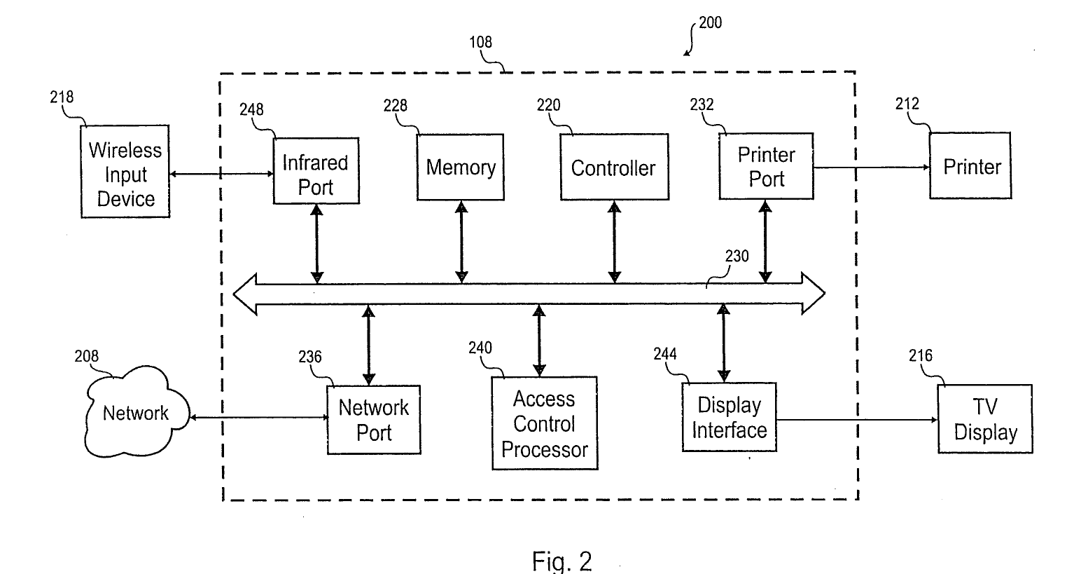

Referring next to FIG. 2, a block diagram of an embodiment of a display system 200 is shown. This embodiment provides multiple levels of object and resource security through a variety of security mechanisms. Included in the display system 200 are a set top box 108, network 208, printer 212, TV display 216, and wireless input device 218. These items cooperate in such a way that the user can enjoy content conditionally distributed by a content provider. The content can include video, audio, software, firmware, interactive TV, data, text, and/or other information. In this embodiment, the content provider is a cable TV provider or multiple system operator (MSO).

The network 208 serves as the conduit for information traveling between the set top box 108 and the headend 104 of the cable TV provider. In this embodiment, the network 208 has one hundred and twenty analog channels and a bi-directional control data channel. Generally, the analog channels carry content and the control data channel carries control and entitlement information. Each analog carrier channel has a number of digital channels multiplexed into one data stream where the digital channels are distinguished by packet identifiers (PIDs). The bi-directional control channel is an out-of-band channel that broadcasts data to the set top boxes 108 at one frequency and receives data from the boxes 108 at another frequency. Return data may be queued to decrease overloading during peak use periods using a store-and-forward methodology well known in the art. Other embodiments could use a cable modem, digital subscriber line (DSL), cellular data, satellite links, microwave links, carrier current transport, or other network connection for both control information and content where the content is formatted as packet switched data.

The printer 212 is an optional accessory some users may purchase and add to their display system 200. When using the set top box 108 for personal computer tasks, the printer 212 allows printing data such as email, web pages, billing information, etc. As will be explained further below, the ability to use a peripheral such as a printer is regulated by an authorization check. Using this regulation feature, printers 212 compatible with the set top box 108 do not work unless proper authorization is obtained to enable that printer 212 for that set top box 108.

The TV display 216 presents the user with audio, text and/or video corresponding to the content. The display 216 typically receives an analog video signal that is modulated on a carrier corresponding to channel three, channel four or a composite channel. The set top box 108 produces a NTSC signal, for example, modulated to the appropriate channel. Other embodiments could use a video monitor or digital display instead of a television display 216. Use of a digital display would alleviate the need for an analog conversion by the set top box 108 because digital displays, such as liquid crystal displays, use digital information to formulate the displayed picture.

The wireless input device 218 allows interaction between the user and the set top box 108. This device 218 could be a remote control, mouse, keyboard, game controller, pen tablet or other input mechanism. An infrared transceiver on the input device 218 communicates with a similar transceiver on the set top box 108 to allow wireless communication. In other embodiments, RF link or wired link could be used instead of the infrared transceiver.

The set top box 108 has component parts that perform authentication and authorization of objects and resources. Objects are any collection of digital information such as software, drivers, firmware, data, video, or audio. The software could include a software program(s) and/or a software dynamic link library or libraries. Resources are anything needed by an object to operate as intended such as another object or a physical device. Included in the set top box 108 are a controller 220, memory 228, a printer port 232, a network port 236, an access control processor 240, a display interface 244, and an infrared (IR) port 248. These blocks communicate with each other over a bus 230 where each block has a different address to uniquely identify it on the bus 230. Typically, the set top box 108 is a separate device, but could be integrated with the TV display 216, a computer, an information appliance, or personal video recorder (PVR).

The controller 220 manages operation of the set top box 108 using a trusted or secure operating system. Such functions as digital object decryption and decompression are performed in the controller 220 as well as functions such as switching TV channels for the user and presenting menus to the user. Included in the controller 220 are a processor, an encryption engine, local memory, and other items common in computing systems.

In other embodiments, the controller 220 could also contain an adjunct secure microprocessor for purposes of key protection or cryptographic processing. This may be appropriate in some systems where a high level of security is desired.

The set top box 108 includes a block of memory 228. This memory 228 is solid state memory that could include RAM, ROM, flash, and other types of volatile and non-volatile memory. Objects and resources are stored in memory for running at a later time. During execution, programs are loaded into and executed within the memory 228, and also use the memory 228 for scratchpad space. Keys, serial numbers and authorizations can be stored in non-volatile flash memory.

This embodiment includes a printer port 232 for interfacing to an optional printer 212. The printer port 232 resource is not available to programs unless authorized. As explained further below, each object must have authorization to use a resource such as the printer port 232. Data is sent from the printer port 232 to the printer 212 in a serial or parallel fashion by way of a wired or wireless transport mechanism.

Stated generally, a checkpoint is a point in time or a step of processing where the authentication and/or authorization status of a functional unit is confirmed. A checkpoint is encountered when printing is requested. The checkpoint authorizes and authenticates the object requesting the printing. Checkpoints are places in one object where authentication and/or authorization are run on another object (e.g., an operating system checks authentication and authorization of an application that is running). Ideally, checkpoints are performed when the purpose of the object becomes manifest. In the case of a printer port 232, its purpose becomes manifest when it is used to print something. Accordingly, a checkpoint is triggered to check the object using the printer port 232 resource when anything is printed. Typically, the checkpoint for printing would be in the operating system.

Other types of objects would have other purposes that would correspond to a checkpoint so as to require authentication and/or authorization when the purpose becomes manifest. For example, an object may be stored in long-term memory. Reading the object from long-term memory would trigger a checkpoint. When the object is loaded into short-term solid-state memory, another checkpoint is encountered. A new signature may be calculated when the object is moved from long-term to short-term memory. Whenever the object is read from short-term and processed by the controller 220, another checkpoint may be encountered. Further, another checkpoint may be encountered if the object is displayed on a screen or played through speakers. Various embodiments could have one or more of these checks performed at different stages of processing by the set top box 200.

The network port 236 allows bi-directional communication between the set top box 108 and the headend 104. Included in the network port 236 are a tuner and a demodulator that tune to analog carrier channels and demodulate an MPEG data stream to allow one-way delivery of content. Also included in the network port 236 is a control data transceiver or cable modem that allows for bi-directional communication of control data information and/or content. To distribute loading of the control data path to the headend 104 more evenly, a store and forward methodology may be used.

Modulation of the digital video signal onto an analog signal compatible with the TV display 216 is performed by the display interface 244. As discussed above, the TV display 216 generally accepts signals modulated on channel three, channel four or a composite channel. For displays that accept a digital input, such as LCD displays, the display interface 244 performs any formatting required by the digital input.

The IR port 248 communicates bi-directionally with a wireless input device 218. Included in the IR port 248 is an IR transceiver that provides the wireless communication path with the input device 218. Other electronics in the IR port 248 convert analog signals received by the transceiver to a corresponding digital signal and convert analog signals sent to the transceiver from a corresponding digital signal. The controller 220 processed the digital signals so that the user can control some of the functions within the set top box 108.

The access control processor (ACP) 240 regulates security functions within the set top box 108. For example, the ACP 240 performs authentication and authorization either under the direction of the controller 220 or independent of the controller 220 as will become clear in the discussion below. To perform its tasks, the ACP 240 includes a processor, RAM and ROM that cooperate to execute software independent of the controller 220. The ACP 240 also includes a decryption engine and a hash function for deciphering content and calculating signatures. Checkpoints are embedded into the software run that trigger the ACP 240 to perform security checks. In this embodiment, the ACP 240 is implemented in hardware, but other embodiments could perform the functions of the ACP 240 in software.

The ACP 240 can also shadow the operating system (OS) to assure proper functioning of the OS. By watching the launch of objects, the ACP 240 can monitor which application objects are running. If necessary, the ACP 240 can kill or stop execution of running applications if a checkpoint detects an error or if authorization expires. Further, the ACP 240 could monitor memory 228 to detect any application not authorized to be in memory 228. Scratchpad memory size could also be monitored to detect applications hiding in scratchpad memory. Additionally, the ACP 240 could randomly execute checkpoints on the objects in memory 228 to confirm their authorization and/or authenticity. Problems encountered by the ACP 240 are reported to either the OS or the headend 104. In these ways, the ACP 240 acts as a software security guard bot within the set top box 108 such that aberrant behavior is detected and reported.

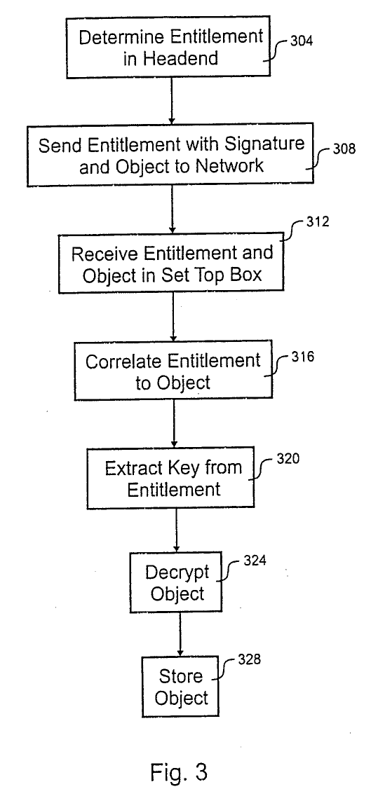

Referring next to FIG. 3, a flow diagram of an embodiment of a process for distributing an object in the first security level is shown. The process begins in step 304 where an entitlement message is formulated in the headend 104. Included in the entitlement message is a key that can decrypt the associated object. In step 308, the entitlement message and object are sent over the network 208 to the set top box 108. After receipt of the entitlement message and object, they are correlated together in step 316. The key is extracted from the entitlement message and used to decrypt the object before it is written to the memory 228 in steps 320, 324 and 328. This process provides both authentication and authorization of the object by using encryption.

In some embodiments, the keys are loaded into the set top box 108 in a controlled environment before shipping the box 108 to the consumer. For example, symmetric or asymmetric keys are loaded into the set top box 108 during assembly at the factory. There could be unique or global keys stored in each box 108 to allow secure multicast or singlecast of content over an encrypted channel. This channel could be used to later add, delete or change keys. The MSO by use of the keys can control access to content without the need for interaction with the user.

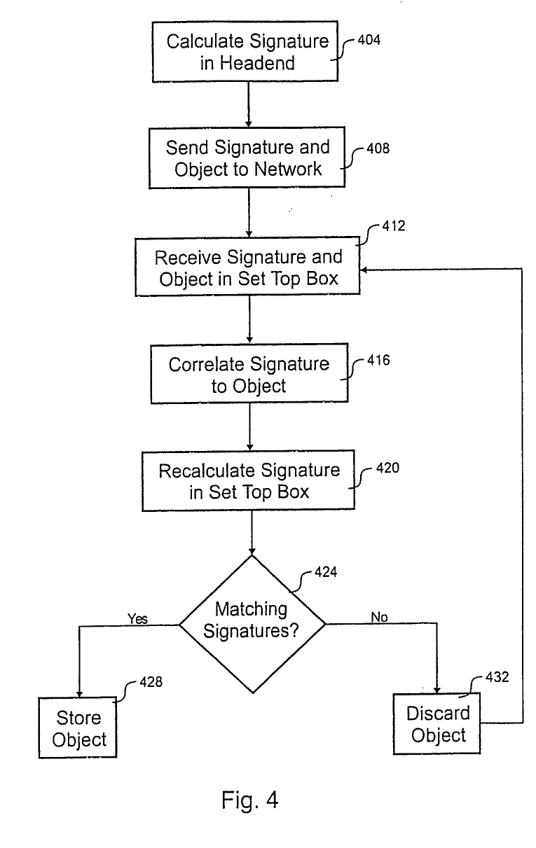

Referring next to FIG. 4, a flow diagram of an embodiment of a process for distributing an object in a second security level is shown. In the second level of security, signatures are used to authenticate an object upon download. In other words, the second level of security imposes a checkpoint on the object when downloaded. The signature is generated over a signatory group that includes portions of an authorization message and object message in the headend 104 in step 404. The authorization message is meta-data related to the object message and the object message contains the object intended for the set top box 108.

In step 408, the signature in the authorization message and the object are separately sent to the set top box 108 over the network 208. Preferably an asymmetric signature is used (e.g., RSA, DSA or ECC based), but a symmetric signature (e.g., DES or triple-DES) could also be used. Upon receipt of the signature and the object and before storing the object, the signature is calculated and checked by the ACP 240 in steps 420 and 424. If the calculated and received signatures match, the object is stored in step 428. Alternatively, the object is discarded in step 432 if there is no match, and processing loops back to step 412 to wait for another copy of the object.

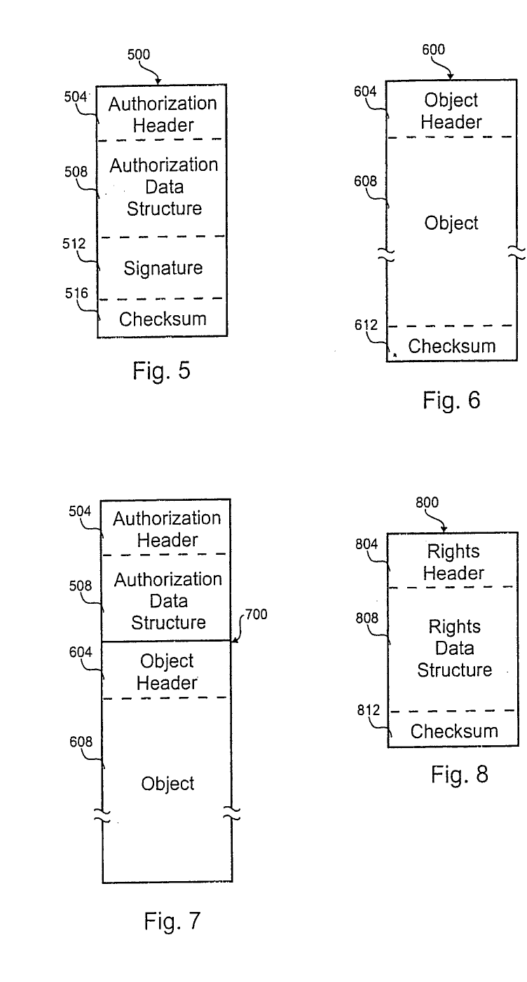

With reference to FIGS. 5-7, an authorization message 500, a software message 600 and a signatory group 700 are respectively shown in block diagram form. Included in the authorization message 500 of FIG. 5 are an authorization header 504, an authorization data structure 508, a signature(s) 512, and a first checksum 516. The authorization message 500 has information used to both authenticate and authorize the software message 600. Forming the software message of FIG. 6 are an object header 604, a software object 608 and a second checksum 612. The software message 600 serves as the transport for the software object 608. The signatory group 700 includes components of the authorization message 500 and software message 600 arranged end-to-end. More specifically, the signatory group 700 of FIG. 7 includes the authorization header 504, authorization data structure 508, object header 604, and software object 608. The signature 512 is calculated over the whole signatory group 700.

The authorization header 504 indicates the configuration of the authorization message 500. Included in the header 504 are a subtype identifier and message version. The subtype identifier distinguishes the various types of authorization messages 500 from one another. In this embodiment, there are authorization message subtypes corresponding to software objects and resources. Software object subtypes have a corresponding software message 600, but resource subtypes do not. Accordingly, the subtype identifier is used to determine if there is a software message 600 associated with an authorization message 500. There may be several types of software object subtypes and resource subtypes for a given system and the message version allows distinguishing the various types.

The authorization data structure 508 provides requirements for a functional unit to the set top box 108. A functional unit is either a software object or a resource. In the case of an authorization message subtype corresponding to a software object, the authorization data structure 508 contains an object or functional unit identifier, a software version, cost information, entitlement information, lifetime information, and one or more program tiers. The object identifier is unique for each software object 608 and allows attributing an authorization message 500 to its corresponding software message 600. Version information is included in the data structure 508 to indicate the version of the software object 608.

Portions of the authorization data structure 508 are used to determine availability of the software object 608 to the set top box 108. The cost information indicates to the set top box 108, and sometimes the user, the price associated with the software object 608. Entitlement information is used to determine if the particular set top box 108 is authorized to accept the software object 608. The entitlement information may include a key if the software object 608 is encrypted with a symmetric key. If the set top box 108 is not authorized for the software object 608, there is no need to process the corresponding software object 608 when it is received. Lifetime information allows expiring of the authorization of the software object 608 to prevent use after a certain date or time. Programming tiers are used to restrict authorization of software objects 608 to predefined tiers such that a set top box 108 can only access software objects 608 within a predetermined tier(s).

The signature 512 is used to verify that portions of both the authorization message 500 and corresponding software message 600 are authentic. A hash function such as SHA-1 or MD5 is run over the whole signatory group, whereafter the result is run through a signing algorithm such as RSA, ECC and DSA to produce the signature. Alternatively, a simple CRC algorithm could be used for the hash function, whereafter the result could be sent through an encryption algorithm such as triple-DES or DES to produce the signature 512. When compiling the authorization message 500, the headend 104 calculates the signature 512 over the whole signatory group 700 before inserting the signature 512 into the authorization message 500. The set top box 108 calculates the signature of the signatory group 700 upon receipt of both the authorization and software messages 500, 600. Once the signature is calculated, it is checked against the received signature 512 to authenticate portions of both the authorization and software messages 500, 600. If the signatures do not match, the set top box 108 discards the software message 600 because it presumably came from an improper source. Some embodiments could use multiple signatures to, among other reasons, support different set top boxes 108 in the system 100.

The first and second checksums 516, 612 are calculated with either linear or non-linear algorithms. These checksums 516, 612 verify the integrity of the data as it is transported to the set top box 108 over the network 216. For example, the checksum could be a cyclic redundancy check (CRC) which performs a binary addition without carry for each byte in the message. The message spooler 208 calculates the checksum 516 as the message 500 is being sent and appends the checksum 516 onto the end of the message 500. Conversely, the set top box 108 calculates the checksum as the message 500 is received and checks the calculated checksum against the checksum 516 in the received message 500. If the calculated and received checksums do not match, an error in transmission has occurred. Messages 500, 600 with errors are discarded whereafter the headend 104 may send replacement messages 500, 600. Some embodiments could use a digital signature rather than a checksum.

The object header 604 includes attributes for the software message 600. Included in the object header 604 are a header length, a software object length, the object identifier, the software version, and a domain identifier. The header length and software object length respectively indicate the lengths of the object header 604 and the software object 608. As described above, the object identifier provides a unique code that allows attributing the authorization message 500 to the software message 600. The software version indicates the version of the software object. Different cable providers are assigned domain identifiers such that all of the set top boxes 108, which might receive a software object 608, can screen for software objects 608 associated with their domain.

The software object 608 includes content the system 200 is designed to deliver to set top boxes 108. Several types of information can be embedded in a software object, such as executable programs, firmware upgrades, run-time programs (e.g., JAVA® or ACTIVEX®), programming schedules, billing information, video, audio, or data. The software object 608 can be used immediately after authentication and authorization or at a later time. Additionally, authorization can be programmed to expire after a certain amount of time.

Referring specifically to FIG. 7, the signatory group 700 is shown. This group 700 is comprised of parts of both the authorization message 500 and the software message 600. All the data used to calculate the signature(s) 512 is included in the signatory group 700. Because the signature(s) 512 requires components from both the authorization message 500 and the software message 600, a failed signature check indicates one of the authorization message 500 and the software message 600 cannot be verified as originating from a trusted source. The trusted source being the headend 104 that generated the signature 512. If there are multiple signatures 512, the set top box 108 chooses at least one signature 512 that it understands to authenticate the signatory group 700.

Referring next to FIG. 8, an embodiment of a “rights” message 800 is shown in block diagram form. The rights message 800 conveys rights to use a functional unit. The functional unit could be an object or a resource. Typically, there is one rights message 800 for each set top box 108, which specifies any rights for all functional units. Requirements from the authorization message 500 that are associated with objects and resources are checked against the rights to determine if interaction with another object or resource is authorized. The rights message 800 allows remotely adding new rights to a functional unit associated with the set top box 108. Although not shown, the rights message 800 typically includes a digital signature to verify the integrity of the message 800 during transport. In some embodiments, a checksum could be used instead of a digital signature.

The rights header 804 includes attributes for the rights message 800. Included in the rights header 804 are a header length, a rights data structure length, a set top box 108 identifier, and a domain identifier. The header length and the rights data structure length respectively indicate the lengths of the rights header 804 and the rights data structure 808. For authentication purposes, the set top box 108 identifier provides a unique code that allows attributing the rights message 800 to a particular set top box 108 in the system 100.

Rights are conveyed to all the functional units using the information in the rights data structure 808. A given functional unit may have rights to use several other functional units. These rights are contained in the rights data structure 808. Each functional unit identifier lists tier rights that are used to attribute the rights to a particular functional unit. The functional unit may be already in the set top box 108 or may be downloaded at some later time.

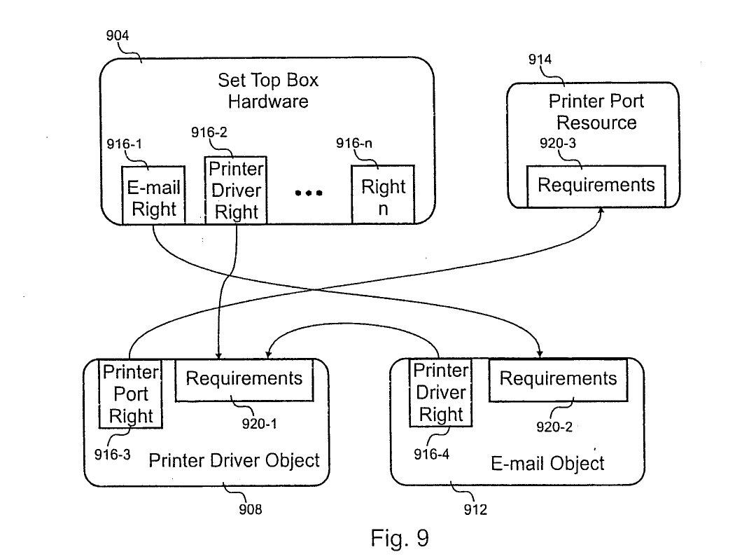

Referring next to FIG. 9, interaction between functional units is shown in block diagram form. The functional units associated with the set top box 108 include a set top box resource 904, a printer driver object 908, an e-mail object 912, and a printer port resource 914. During the normal interaction of these functional units, checkpoints are encountered that trigger authorization checks. The sole table correlates rights and requirements to each functional unit in FIG. 9. The functional unit identifier serves to correlate the object messages 600 with the rights messages 800.

TABLE

| Functional Unit ID | Functional Unit | Requirements | Rights |
|---|---|---|---|
| 904 | Set Top Box | NA | E-mail, Printer |
| | | | Driver, etc. |
| 912 | E-mail | Yes | Printer Driver |
| 908 | Printer Driver | Yes | Printer Port |
| 914 | Printer Port | Yes | None |

The set top box resource 904 is superordinate to the email object 912. When the email object 912 is loaded, a checkpoint in the object 912 checks for proper rights. The proper rights are defined by the requirements 920-2 of the email object 912 itself. If the e-mail right 916-1 meets the standards of the e-mail object requirements 920-2, the e-mail object 912 continues execution past the checkpoint. The ACP 240 actually performs the authentication after the e-mail right 916-1 and e-mail object requirements 920-2 are respectively loaded by their associated functional units 904, 912.

After the user receives the set top box 904, the user can add an optional printer 212. In this embodiment, the ability to print is an added feature that is not included in all set top boxes 904. If the printer 212 is a purchase sanctioned by the content provider, printer driver rights 916-2, 916-4 and a printer port right 916-3 are sent in rights messages 800 to the set top box 904 from the headend 104.

Some embodiments could provide rights to a subset of the functional units capable of using the printer port 920-3. For example, the e-mail object 912 could be given the printer driver right 916-4, but the set top box resource 904 would not receive the printer driver right 916-2. In this way, only the email object 916-2 could use the printer port 920-3 and the other objects could not.

Hooking the printer 212 to the printer port 914 can trigger display of a message on the TV 216 that asks for a secret code included with the printer 212. After the user enters the secret code, a request for the rights messages 800 that enable the printer 212 is made to the headend 104. Once the headend 104 receives and verifies the secret code, an enabling set of rights messages 800 are sent encrypted in a key based upon the secret code. In this embodiment, the printer driver object 908 is factory loaded, but other embodiments could load this object 908 when needed using an object message 600.

While the e-mail object 912 is running, the user may try to print an e-mail message. Several checkpoints authenticate the proper rights 916 are present before printing. The e-mail object 912 calls the printer driver 908 with the information requiring printing. A checkpoint in the printer driver 908 stops processing until the authorization of the e-mail object 912 is checked. A printer driver right 916-4, downloaded when the printer was purchased, is loaded into the ACP 240 along with the printer driver requirements 920-1 for authentication. Presuming authentication is successful, the printer driver object 908 formats the print information for the printer 212 and passes it to the printer port resource 914.

The printer port resource 914 is the hardware port that interfaces to a cable connected to the printer 212. Once information is sent to the printer port resource 914 a checkpoint pauses the processes to check that the printer driver object 908 has proper authorization. The requirements 920-3 and rights 916-3 are loaded into the ACP 240 for authentication. Once the use by the printer driver object 908 is authenticated, the remainder of the print job is spooled to the printer port resource 914 for printing.

In some embodiments, the rights 916 of one functional unit can be inherited by another functional unit. The right 916 could be conveyed to other objects 608 that might use that functional unit. For example, the right 916 to use the printer port 232 could initially be associated with the e-mail object 912 alone, where this right 916 is conveyed to e-mail object 912 when the user purchased a printer 212. At a later time, the headend 104 could authorize inheritance of that right 916 to all other functional units or subset of the functional units that might use the printer port 232. In this way, additional functional units could use the print feature.

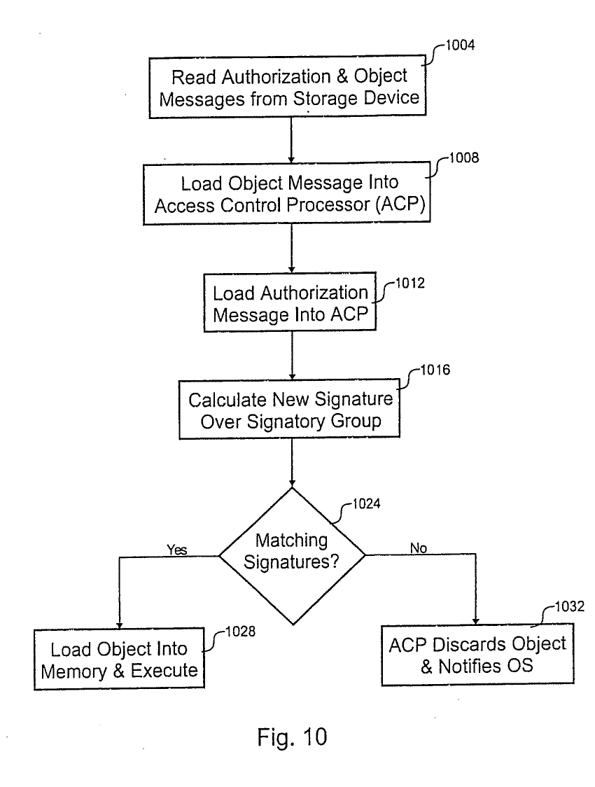

Referring next to FIG. 10, an embodiment of a process for loading an object in a third security level is depicted. This embodiment authenticates the network operator is the source of the object before launch. In a first step 1004, the controller 220 reads the authorization and object messages 500, 600 from a non-volatile portion of the memory 228. The object message 600 is loaded into the ACP 240 in step 1008 and the authorization message 500 is loaded in step 1012.

Once both object and authorization messages 600, 500 are loaded, all the components of the signatory group 700 are available to the ACP 240. In step 1016, the ACP 240 calculates the signature over the signatory group 700. The ACP 240 makes a determination in step 1024 as to whether the signature 512 in the authorization message 500 matches the calculated signature. If there is a match, the object 608 is authorized and the object 608 is loaded into memory 228 by the OS and allowed to execute. Alternatively, the ACP 240 discards the object 608 and notifies the OS of an error if the signatures do not match. A signature 512 mismatch could result from corruption during storage, a pirate replacing the object 608 or a virus corrupting the object 608.

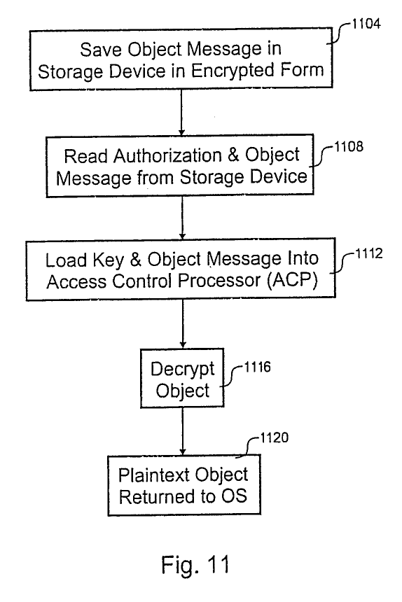

With reference to FIG. 11, a flow diagram of an embodiment of a process for loading an object in a fourth security level is shown. This embodiment checks that the set top box 108 is authorized to use the object prior to launching the object 608. Similar to level one security explained above, this embodiment uses encryption to achieve the authorization check. Either symmetric or asymmetric keys could be used for the encryption. In a first step 1104, the object message 600 is written in encrypted form to a non-volatile portion of the memory 228. In some embodiments, the object message 600 is received from the network 208 in encrypted form such that an additional encryption step would be unnecessary before storage.

When loading the object 608 is desired, the authorization and object messages 500, 600 are retrieved from the non-volatile memory 228 in step 1108. The authorization message 500 includes a key necessary to decrypt the object message 600. The key and the object message 600 are loaded into the ACP in step 1112. The object 608 is decrypted in step 1116. If the key used for decryption is not the one that is authorized for the object 608 the decryption process will be unsuccessful and the resulting product will be undecipherable. Alternatively, the plaintext object is returned to the OS for execution if the key is correct in step 1120.

In one embodiment, the object 608 is loaded into volatile memory in encrypted form. Since only the object 608 from the object message 600 is stored in memory, the object 608 is encrypted by itself. The same key or a different key could be used to perform the encryption. When subsequent checkpoints are encountered, the authorization can be performed on the encrypted object 608 in memory. For example, when the object 608 is read from memory for playback or viewing it is decrypted to once again verify authorization. User interaction, such as entry of a password, is not required during the authorization process.

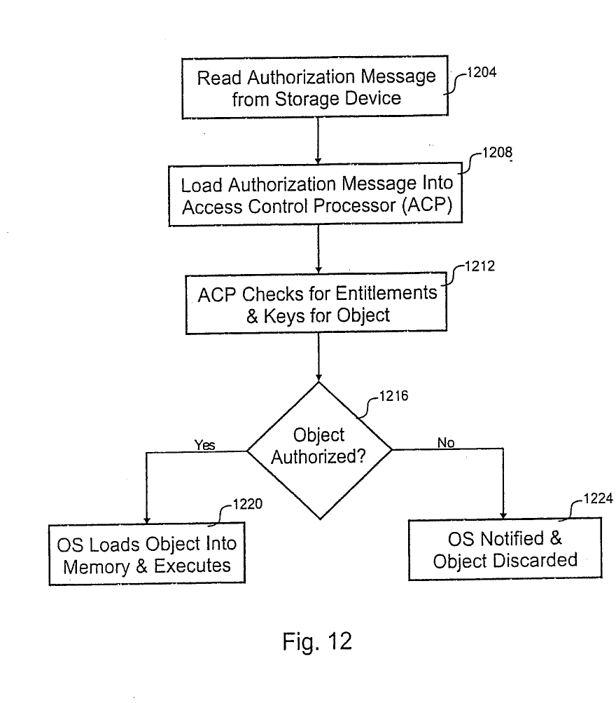

Referring next to FIG. 12, a flow diagram of another embodiment of a process for loading an object in the fourth security level is illustrated. In this embodiment, entitlements in the authorization message 500 are checked in order to confirm the object 608 is authorized before it is loaded. In step 1204, the authorization message 500 is read from the memory 228. Next, the controller 220 loads the authorization message 500 into the ACP 240 in step 1208.

Once the ACP 240 has the authorization message 500, the entitlement information therein is checked in step 1212. A determination is made in step 1216 as to whether the object 608 is authorized by checking the entitlement information. If the object 608 is authorized, it is loaded into memory by the OS and executed. Alternatively, the OS is notified of a failed authorization attempt and object 608 is discarded in step 1224 if there is no entitlement to use the object 608.

Although not expressed above, the authorization of level four is typically performed at about the same time as the authentication of level three and before an object 608 is loaded. Authorization is performed prior to authentication because authorization is a quicker process. After the performance of authentication and authorization, the status returned to the OS is NOT AUTHORIZED, AUTHORIZED BUT NOT AUTHENTICATED, or AUTHORIZED AND AUTHENTICATED.

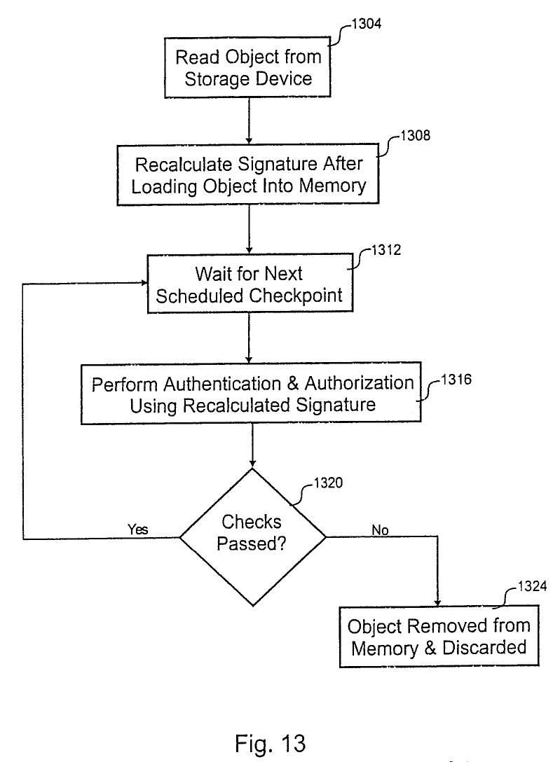

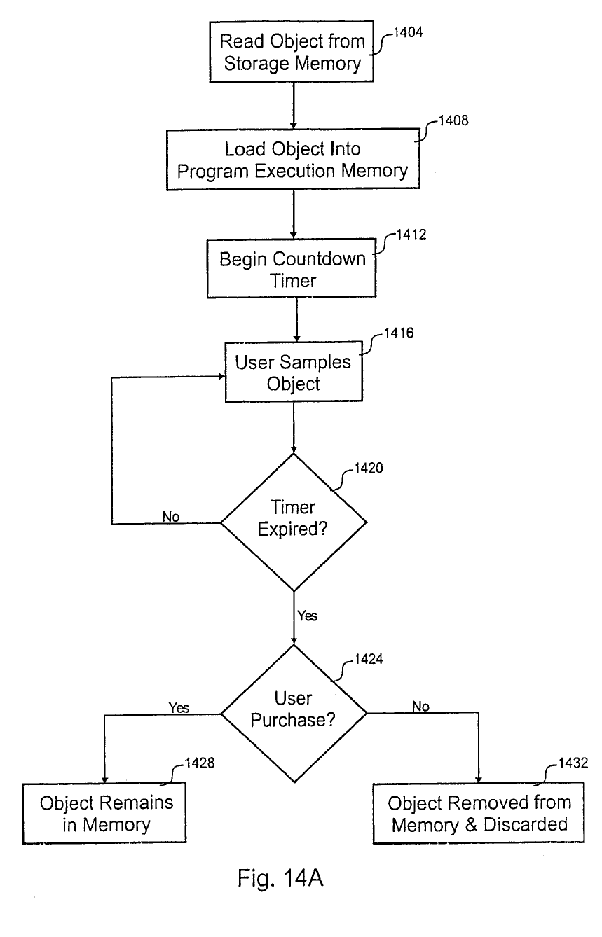

With reference to FIG. 13, a flow diagram of an embodiment of a process for checking continuously running objects in a fifth security level is depicted. The fifth security level and sixth security level (described below) relate to checkpoints triggered by time or usage. As can be appreciated, objects that are running should also be authenticated to be sure they haven't been replaced or modified. Additionally, verifying authorization periodically allows the expiration of an application that has been continuously running for a period of time. A predetermined period can be used or an unpredictably changing period can also be used.

The process begins in step 1304 where the object 608 is read from the memory 228. Before loading the object 608 it has a first signature, but after loading the object 608 into memory 228, the signature of the loaded object 608 may change. As those skilled in the art appreciate, the addresses are translated from virtual addressing to physical addressing such that the signature can change. Accordingly, the signature is recalculated in step 1308 to produce a second signature indicative of the loaded object. It is noted, the object 608 should be loaded and maintained in memory 228 in such a way that the second signature does not change. For example, the loaded object should not have self-modifying code such that the signature would change. Some embodiments, however, could allow modifications to the second signature as changes occur.

The OS has checkpoints scheduled at regular intervals that trigger periodic authentication and authorization. In step 1312, the process waits for the next scheduled checkpoint. Typically, these scheduled checkpoints occur at least weekly or monthly. As cable TV services are paid monthly, checking for unauthorized continuously running applications after the billing cycle is desirable, however, any interval could be used. Authentication and authorization is performed in step 1316 by loading the authorization message 500, loaded object and second signature into the ACP 240. The second signature is used for authentication.

A determination is made in step 1320 as to whether the authentication and authorization performed in step 1316 were both performed successfully. If successful, the process loops back to step 1312 where the process waits for the next checkpoint. Alternatively, the object is removed from memory 228 and discarded when either the authorization or authentication checks fail. Preferably, the ACP 240 is the time source for determining the scheduled checkpoints. The ACP 240 is less susceptible to attacks that set the clock back to avoid expiration of authorization. Additionally, the ACP 240 does not run application software that could change the time and requires secure commands to change the time. Secure commands could use encryption or signatures to guarantee authenticity of any time changes. To expire authorization, keys used for decryption could be expired or a new rights message 800 could be sent that overwrites and removes the right to use an object.

Although the preceding embodiment relies upon time periods to trigger checkpoints, other embodiments could trigger checkpoints in other ways. For example, usage could be monitored with a counter to trigger a checkpoint. After a predetermined number of loads or a predetermined cumulative running-time, a checkpoint could require re-verification of the object.

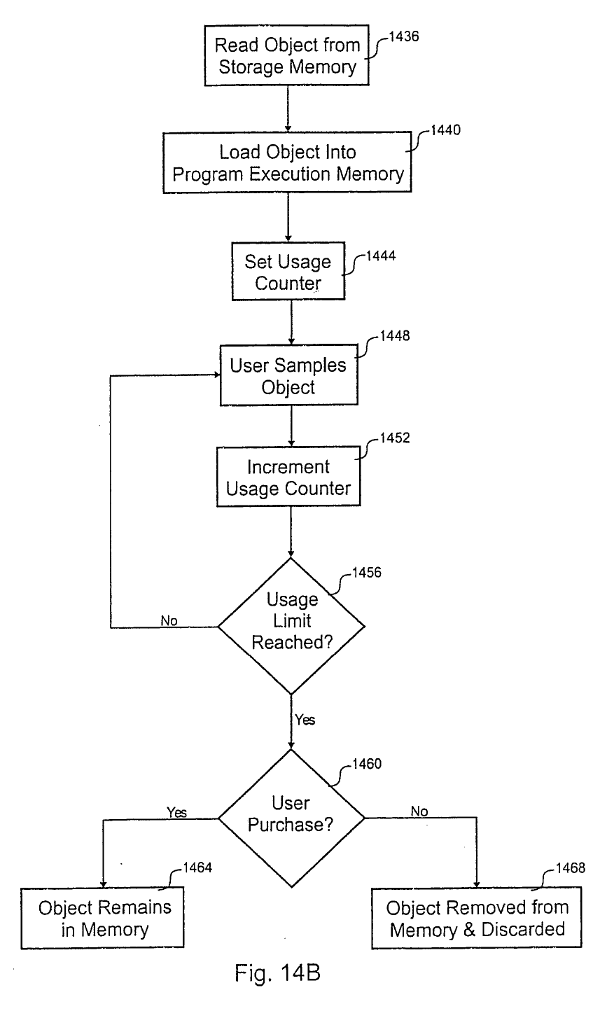

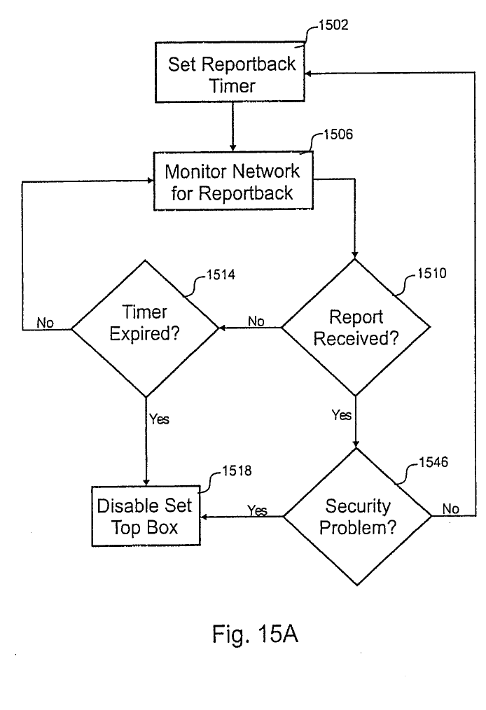

Referring next to FIG. 14A, a flow diagram of an embodiment of a process for allowing a free preview of an object in security level six is illustrated. The sixth level of security allows using the software based upon some exemplar before a purchase is required. As is well known in the art, users desire to try software before possibly purchasing it. Accordingly, the sixth level of security allows using the software for a period of time before a purchase is requested.

The process begins in step 1404 where the object 608 is retrieved from a storage portion of the memory 228. In step 1408, the object 608 is loaded into an execution portion of the memory 228 where execution of the object 608 is initiated. A countdown timer is begun in step 1412 that counts down to zero to mark the end of the trial period. It is to be understood a count-up timer could alternatively determine expiration of the trial period. The user samples the object 608 in step 1416 until the trial period ends. Completion of the sample period is determined in step 1420 by noting when the countdown timer expires or reaches its lower bound of zero. When the timer expires, so does a temporary authorization of the trial period.

The user is given the option to purchase the object 608 in step 1424 while authorization of the application is suspended. Purchase will reinstate authorization. A purchase screen is formulated and presented to the user by the set top box 108 to prompt purchase of the object 608. If no purchase is selected, the object 608 is removed from memory 228 and discarded in step 1432. Alternatively, the object 608 remains in memory 228 and the entitlement information is updated to reflect the purchase and authorization in step 1428 if the purchase is consented to.

Other embodiments could use crippled demonstration software that can run forever, but is missing some features present in the purchased version. If the user likes the crippled version, the user is likely to purchase the full version to get the missing features. Purchase un-cripples the object 608 and authorizes the missing features. It is noted that in some embodiments that the full version may be subject to expiration of the right to use the application in a manner similar to that depicted in FIG. 13.

Referring next to FIG. 14B, a flow diagram of another embodiment of a process for allowing a free preview of an object in security level six is illustrated. In this embodiment, the trial period for the object is defined by a number of uses or some other measurement. For example, a software program could be loaded twice before requiring purchase.

The process begins in step 1436 where the object 608 is retrieved from the storage portion of memory 228. In step 1440, the object 608 is loaded into the program execution portion of memory 228 where execution is performed. A count-up usage counter is begun in step 1444 that counts-up when the object is used. It is to be understood a count-down counter could alternatively determine when the usage limit is reached. The user samples the object 608 in step 1448 and the sampling causes increment of the usage counter in step 1452. Each usage count in this embodiment corresponds to a program load or some other action. Completion of the sample period is determined in step 1456 by noting when the usage counter reaches its upper bound. When the limit is reached, the trial period authorization is expired.

The user is given the option to purchase the object 608 in step 1460 while authorization of the application is suspended. Purchase will reinstate authorization. A purchase screen is formulated and presented to the user by the set top box 108 to prompt purchase of the object 608. If no purchase is selected, the object 608 is removed from memory 228 and discarded in step 1468. Alternatively, the object remains in memory and the entitlement information is updated to reflect the purchase and authorization in step 1464 if the purchase is consented to.

Although the preceding embodiment measures usage of the whole object 608, other embodiments could monitor usage in more sophisticated ways. Individual functions of the object 608 could have metered access. For example, an e-mail program could be allowed to print twenty e-mail messages before requiring purchase of the print capability.

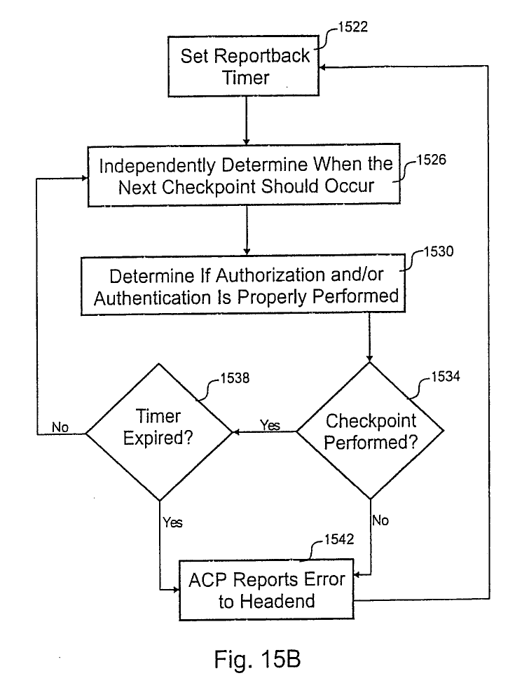

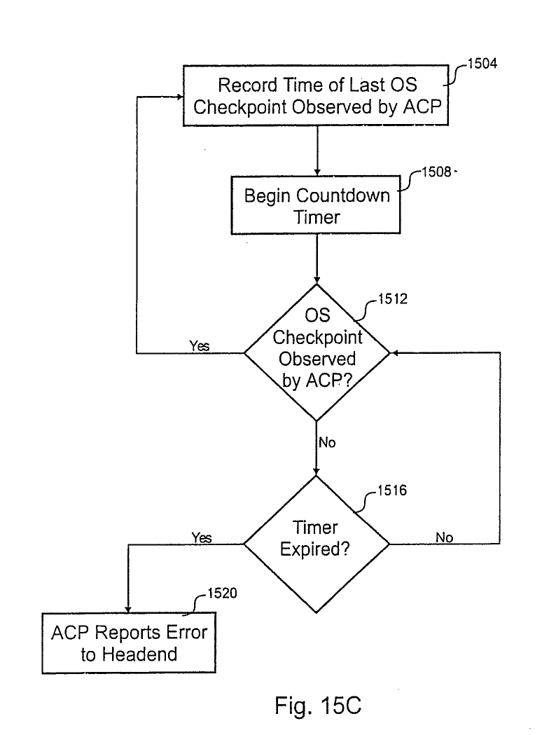

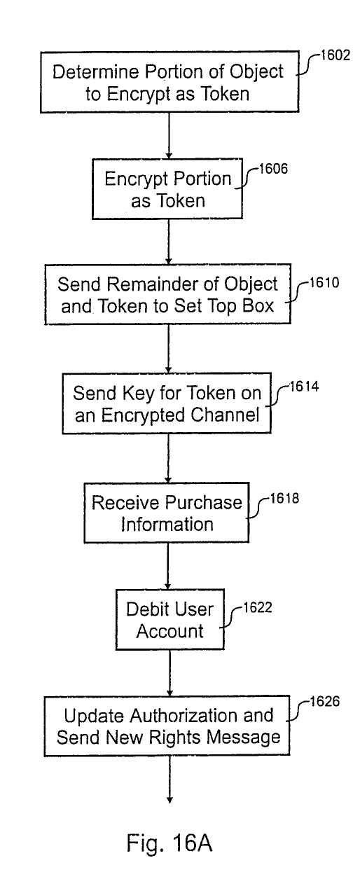

With reference to FIG. 15A, a flow diagram showing an embodiment of a process for monitoring reports back to a headend 104 in security level seven is shown. A monitoring computer in the headend 104 expects each ACP 240 in the system 100 to periodically send a security report back the headend 104 through the network 208. Those ACPs 240 that fail to report back within a predetermined period are presumed to have malfunctioning ACPs 240, which could indicate a hacked or otherwise malfunctioning set top box 108. In this embodiment, the headend expects at least one security report each day. Only the process for monitoring a single set top box 108 is shown in FIG. 15A, but it is to be understood that the process is performed in parallel on a large number of set top boxes 108 in the system 100.

In step 1502, a reportback timer is set to an initial value of one day. After setting, the reportback timer starts counting down in time. For the set top box 108 subjected to this process, the headend 104 monitors for any reportback from the set top box 108 in step 1506. In step 1510, a test is performed to determine if the security report has been received. If the report is received, processing continues to step 1546 where the report is analyzed for any identified security problems. Where there are security problems, the set top box 1518 may be disabled in step 1518. Where there are no security problems, processing loops back to step 1502.

If no report is received before step 1510, processing continues to step 1514 where a further test is performed to determine if the reportback timer has expired. If the timer has not expired, processing loops back to step 1506. The set top box 108 corresponding to the expired timer is disabled in step 1518, if the timer has expired. An expired timer would indicate the ACP 240 is no longer properly reporting security problems. To disable the set top box 108, a new rights message 800 could be sent that disables a key function of the set top box 3 in step 1518 such as the infrared port resource. Further, a message could be displayed on the set top box 108 informing the user to contact customer support to re-enable the infrared port resource.

Although this embodiment disables the whole set top box in response to an unfavorable security report, some embodiments could disable only the object 608 that caused the security problem. If the operating system (OS) in the set top box 108 becomes corrupted in memory, for example, subsequent checkpoints may not be properly responded to. The ACP 240 would report this error after observing checkpoints going unperformed. A command to the set top box 108 could be sent by the headend 104 to cause reload of the OS in the hope of clearing out the error. If further reports are received, the set top box 108 could be disabled.

Referring next to FIG. 15B, a flow diagram showing an embodiment of a process for reporting security checks by a set top box 108 in security level seven is shown. The ACP 240 monitors for proper operation of objects 608 and the OS when checkpoints are, or should be, encountered. For example, some embodiments execute a checkpoint whenever an object 608 is loaded, launched or accessed. The ACP 240 would make sure that authentication and/or authorization is performed and that any unfavorable results are acted upon. Failure to handle checkpoints properly is reported to the headend 104 in a security report.

In step 1522, a reportback timer is set. The reportback timer sets the period at which the set top box 108 will normally send security reports back to the headend 104. In this embodiment, the ACP 240 sends reports every hour. These reports are in addition to authentication and authorization error reports from the OS and controller 220. The ACP 240 independently determines when a checkpoint should be encountered by the OS and objects 608 in step 1526. In steps 1530 and 1534, the ACP 240 determines if authentication and/or authorization were performed in response to the checkpoint. If either test fails, the ACP 240 further determines if the error is reported back to the headend 104 by the controller 220. The ACP 240 is involved in the authentication and/or authorization process and can determine when these processes are performed. The monitoring of error reports can be done by the ACP 240 auditing traffic on the system bus 230 to see if the network port 208 is properly sent the error report.

If a checkpoint is ignored or otherwise not acted upon, a security report is immediately sent to the headend 104 in step 1542. The security report includes all errors that occurred since the last reportback timer period began. If the checkpoint is properly performed, processing continues to step 1538 where expiration of the one-hour report back period is tested. A security report is sent by the ACP 240 when the timer expires in step 1542, otherwise, processing loops from step 1538 back to step 1526 for further monitoring. In this embodiment, the ACP 240 performs simple checks on the rest of the set top box 108 to independently check for security problems and also reports those problems back to the headend 104.

With reference to FIG. 15C, another embodiment of a process for monitoring security checks in security level seven is depicted in flow diagram form. In this embodiment the ACP 240 shadows the OS to double-check that checkpoints are encountered regularly. The process begins in step 1504 where the time of the last OS checkpoint is recorded. Since the ACP 240 is involved in the authentication and authorization process in this embodiment, the ACP 240 can track execution of checkpoints. In step 1508, the countdown timer is started. We note once again that this counter could also count-up rather than-down.

In step 1512, a determination is made as to whether a checkpoint was observed by the ACP 240. If a checkpoint was observed, processing loops back to step 1504 where the countdown timer is reset so as to start again from the beginning. Alternatively, a check of the timer is performed in step 1516 if no checkpoint is observed. If the counter has not expired, processing loops back to step 1512 to test once again for the observation of a checkpoint. When the timer does expire without reaching a checkpoint, processing continues to step 1520 where the ACP 240 reports an error back to the headend 104.

Although the above embodiment discusses testing for checkpoints on a single object 608, it is to be understood that testing for checkpoints may occur for each object 608 in the set top box 108 in the manner described above such that many of the depicted processes are performed in parallel. In some embodiments, custom criteria may be designed for each object 608 in order to detect errors in the execution unique to that object 608. Additionally, we note a trusted or secure operating system normally may not need an ACP 240 to check for aberrant behavior in such a rigorous manner. To thwart hackers, pirates, viruses, and memory errors, checking for normal functioning of the operating system (i.e., check for regular checkpoints) adds an extra layer of security.

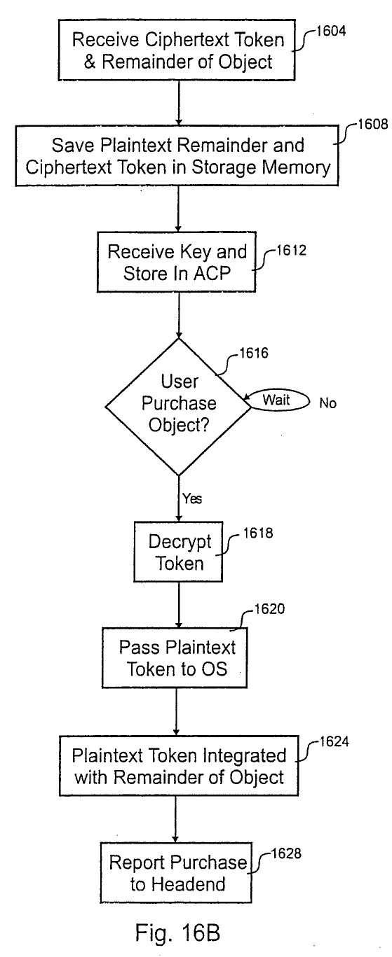

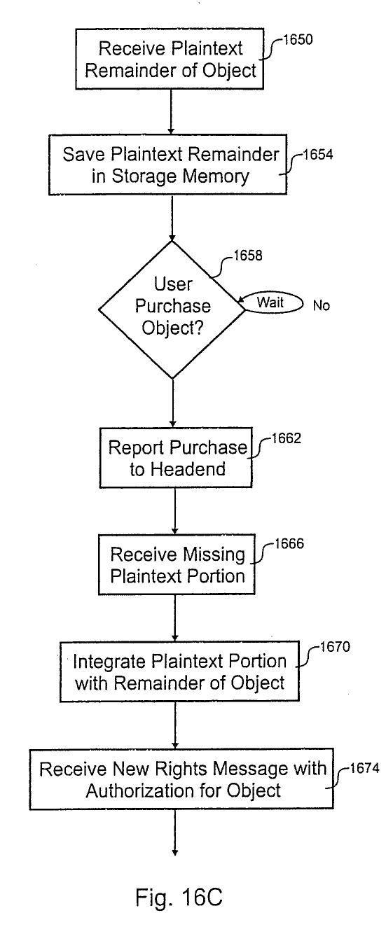

With reference to FIG. 16A, a flow diagram of an embodiment of a process for producing partially-encrypted objects in an eighth level of security is shown. A portion of the object is encrypted to prevent unauthorized launches of the object until the object 608 is purchased. For example, a crippled version of the object 608 could be made available until purchase causes decryption of a token in order to reformulate an un-crippled version of the object 608. Decrypting the token effectively authorizes use of the un-crippled version such that the whole object 608 is available in plaintext form. In this embodiment, the portion of the object 608 used for the token is less than half the size of the whole object 608.

Processing begins in step 1602 where the portion of the object 608 to encrypt as a token is chosen. The portion is chosen such that its absence from the object 608 does not allow execution of the object 608. The portion removed is encrypted as a token in step 1606. Either symmetric or asymmetric encryption may be performed, however, this embodiment uses symmetric encryption. In step 1610, the crippled or secure object is sent to the set top box 108. Included in the secure object are the token and the remainder of the object 608 in plaintext form. In step 1614, the symmetric key is sent to the set top box 108 over a secure channel.

If the user purchases the object 608, the token is decrypted and reinserted into the object 608 such that the reformulated object is executable. A message is sent to the headend 104 from the set top box 108 in step 1618 indicating a purchase was made. In step 1622, the user's account is properly debited for the purchase of the object 608. An updated rights message 800 is sent that authorizes use of the object in step 1626. Although this embodiment gets final authorization from the headend 104, some embodiments could avoid this authorization to begin use of the object immediately. For example, authorization from the headend 104 may be impractical in store-and-forward systems.

Referring next to FIG. 16B, a flow diagram of an embodiment of a process for using tokens to achieve the eighth level of security is shown. This embodiment uses a ciphertext token to control authorization of an object 608. The ciphertext token is an encrypted portion of the object 608 needed for normal operation of the object 608 or some sub-function thereof. Decryption of the ciphertext token produces a plaintext token that is inserted into the object 608 such that the object is reformulated in plaintext form.

In step 1604, the process begins by receiving the ciphertext token and the plaintext remainder of the object 608 from the headend. Although this embodiment relies upon the headend 104 to create the ciphertext token, some embodiments could perform the encrypting of the token in the set top box 108 after object 608 is received. The plaintext remainder and ciphertext token are stored in storage memory 228 in step 1608. The key needed to decrypt the ciphertext token is received and stored in the ACP 240 in step 1612.

The process waits in step 1616 until the user purchases the object 608. In step 1618, the ciphertext token is removed from the object 608 and sent to the ACP 240 for decryption. The resulting plaintext token is returned to the OS and integrated into the object 608 to make the object 608 functional in steps 1620 and 1624. In step 1628, the purchase is reported to the headend 104. Before execution of the object 608, further authorization from the headend 104 in the form of a rights message 800 may be required. By encrypting only a portion of the object 608 rather than the whole object 608, the decryption process is accelerated.

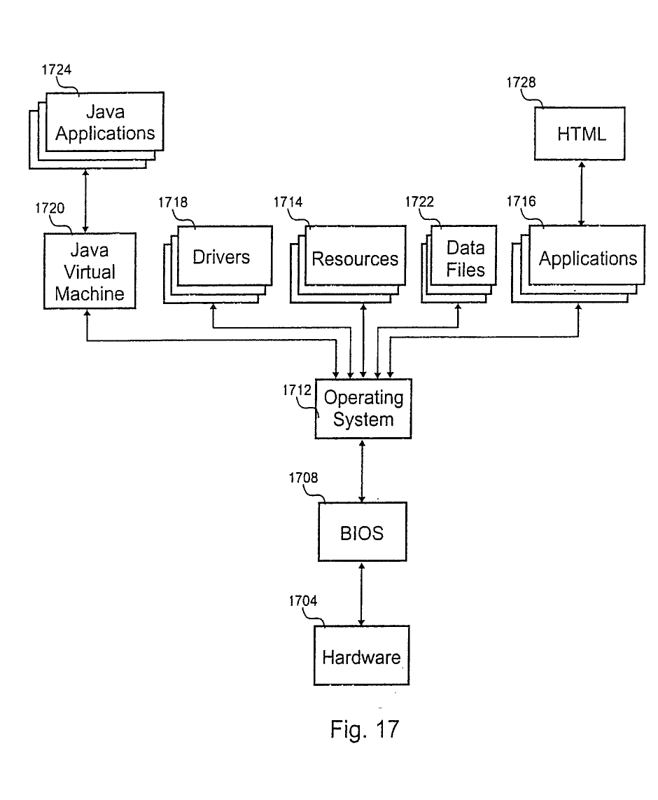

The above discussion relates to running applications or objects 608 on an OS. These concepts are equally applicable to run-time programs such as JAVA® applications running on a JAVA® virtual machine (JVM) which runs on top of the OS. To aid in this abstraction, the concept of superordination and subordination are explained in relation to FIG. 17. Superordination and subordination define which object 608 has the responsibility to impose a checkpoint upon another object. Checkpoints are imposed on objects 608 during the normal interaction that occurs with other objects 608 and resources.

With reference to FIG. 16C, a flow diagram of another embodiment of a process for using partial download to achieve the eighth level of security is shown. This embodiment divides the object into a plaintext portion and a plaintext remainder. The headend 104 distributes the plaintext remainder, but waits for a purchase before distributing the plaintext portion. Without the plaintext portion, the object 608 is crippled such that it cannot be executed. In this embodiment, the plaintext portion is less than one-tenth the size of the plaintext remainder.

In step 1650, the plaintext remainder of the object 608 is received by the set top box 108 and stored in memory 228 in step 1654. Nothing is done to the plaintext remainder unless the user purchases use of it in step 1658. The purchase is reported back to the headend 104 by way of the network 208. Once any verification is performed upon the purchase request, the headend 104 sends the missing plaintext portion that is received in step 1666. A secure channel is used to send the plaintext portion to the set top box 108 that purchased the object 608.

In step 1670, the plaintext portion and remainder are joined to reformulate the object 608 at the set top box 108. This embodiment further requires a new rights message 800 from the headend 104 to enable use of the object. The new rights message 800 would replace the old rights message 800 and provide rights to use the object 608.

With reference to FIG. 17, some of the functional units of a set top box 108 are shown. Functional units toward the bottom of FIG. 17 are superordinate to the functional units near the top of FIG. 17. That is to say, functional units toward the top of FIG. 17 are subordinate to those lower in the figure. Superordinate functional units are responsible for imposing checkpoints on subordinate functional units. For example, the hardware 1704 imposes checkpoints upon the BIOS 1708, OS 1712 and so on up the subordination hierarchy. The BIOS 1708 imposes checkpoints on the OS 1712, but not upon the hardware 1704. Functional units in the same ordination stratum can impose a checkpoint on another functional unit in that stratum when they interact. For example, an application 1716 can require execution of a checkpoint on a driver 1718.

Superordinate functional units are designed to initiate execution of the checkpoints in conjunction with the ACP 240 and subordinate objects are designed to have checkpoints imposed upon them. For example, the BIOS 1708 requires execution of a checkpoint upon the OS 1712 during the boot process, during execution and/or periodically while running. A driver object 1718 is subject to checkpoints when installed or exercised during normal operation. Data file objects 1722 are subject to checkpoints whenever the data in the file is accessed. An HTML object 1728 is reviewed as part of a checkpoint whenever the HTML object 1728 is interpreted by a browser application 1716.

In light of the above description, a number of advantages of the present invention are readily apparent. Authorization is further enhanced by obscuring part of the object. Some embodiments do not send the missing portion to the set top box until a purchase request is made such that authorization involves the headend, which is less susceptible to corruption.

While the principles of the invention have been described above in connection with specific apparatuses and methods, it is to be clearly understood that this description is made only by way of example and not as limitation on the scope of the invention.

What is claimed is:

1. A method for securing an object within a content receiver, the method comprising steps of:
receiving a first portion of the object;
recognizing a purchase request from a user of the content receiver for the object;
reporting the purchase request to a point away from the content receiver;
receiving a second portion of the object after the reporting step; and
storing the object in the content receiver.

2. The method for securing the object within the content receiver as recited in claim 1, wherein the second portion is received in encrypted form.

3. The method for securing the object within the content receiver as recited in claim 1, wherein the first portion is greater than nine hundred percent larger than the second portion.

4. The method for securing the object within the content receiver as recited in claim 1, further comprising the step of reformulating the object from the first and second portions.

5. The method for securing the object within the content receiver as recited in claim 1, wherein the second listed receiving step comprises a step of receiving the second portion by way of a secured distribution channel.
